(19) United States
(12) Patent Application Publication
(10) Pub. No.: US 2025/0336152 A1
(43) Pub. Date: Oct. 30, 2025

(54) Avatar Generation using Image Diffusion Models

(71) Applicant: Google LLC, Mountain View, CA (US)

(72) Inventors: Nikolaos Kolotouros, Zürich (CH); Thiemo Andreas Alldieck, Zürich (CH); Enric Corona Puyane, Zürich (CH); Eduard Gabriel Bazavan, Zürich (CH); Cristian Sminchisescu, Zürich (CH)

(21) Appl. No.: 19/188,499

(22) Filed: Apr. 24, 2025

Related U.S. Application Data
(60) Provisional application No. 63/638,076, filed on Apr. 24, 2024.

(51) Int. Cl. G06T 17/00; G06T 13/40

(52) U.S. Cl. CPC G06T 17/00; G06T 13/40; G06T 2200/24

(57) ABSTRACT

A method of generating a 3-dimensional representation of a subject is provided. The method includes receiving one or more descriptions characterizing the subject. The method also includes inputting the one or more descriptions characterizing the subject into a first specialized network of a machine learning model to generate one or more images depicting the subject according to the one or more descriptions. The method further includes inputting the generated one or more images to a second specialized network of the machine learning model to generate the 3-dimensional representation of the subject according to the one or more descriptions characterizing the subject.

### CROSS-REFERENCE TO RELATED APPLICATIONS

The present application is a non-provisional patent application claiming priority to U.S. Provisional Patent Application No. 63/638,076, filed on Apr. 24, 2024, the contents of which are hereby incorporated by reference.

### BACKGROUND

Convolutional neural networks (CNNs) have been used across neural architecture across a wide range of tasks, including image classification, audio pattern recognition, text classification, machine translation, and speech recognition. Convolution layers, which are the building block of CNNs, may project input features to a higher-level representation while preserving their resolution.

### SUMMARY

In an embodiment, a method of generating a 3-dimensional representation of a subject is provided. The method includes receiving one or more descriptions characterizing the subject. The method also includes inputting the one or more descriptions characterizing the subject into a first specialized network of a machine learning model to generate one or more images depicting the subject according to the one or more descriptions. The method further includes inputting the generated one or more images to a second specialized network of the machine learning model to generate the 3-dimensional representation of the subject according to the one or more descriptions characterizing the subject.

In another embodiment, a system of generating a 3-dimensional representation of a subject is provided. The system includes a computing device configured to receive one or more descriptions characterizing the subject. The computing device is also configured to input the one or more descriptions characterizing the subject into a first specialized network of a machine learning model to generate one or more images depicting the subject according to the one or more descriptions. The computing device is further configured to input the generated one or more images to a second specialized network of the machine learning model to generate the 3-dimensional representation of the subject according to the one or more descriptions characterizing the subject.

In another embodiment, a non-transitory computer readable medium is provided which includes program instructions executable by at least one processor to cause the at least one processor to perform functions of generating a 3-dimensional representation of a subject. The functions include receiving one or more descriptions characterizing the subject. The functions also include inputting the one or more descriptions characterizing the subject into a first specialized network of a machine learning model to generate one or more images depicting the subject according to the one or more descriptions. The functions additionally include inputting the generated one or more images to a second specialized network of the machine learning model to generate the 3-dimensional representation of the subject according to the one or more descriptions characterizing the subject.

In a further embodiment, a system is provided that includes means for generating a 3-dimensional representation of a subject. The system includes means for receiving one or more descriptions characterizing the subject. The system also includes means for inputting the one or more descriptions characterizing the subject into a first specialized network of a machine learning model to generate one or more images depicting the subject according to the one or more descriptions. The system additionally includes means for inputting the generated one or more images to a second specialized network of the machine learning model to generate the 3-dimensional representation of the subject according to the one or more descriptions characterizing the subject.

In an embodiment, a method comprises receiving image training data comprising images and associated image descriptions. The method additionally includes applying a first specialized network to the image training data to obtain a trained first specialized network. The method further includes receiving 3-dimensional representation training data comprising images and associated 3-dimensional representations. The method also includes applying a second specialized network to the 3-dimensional training data to obtain a trained second specialized network. The method additionally includes determining a trained machine learning model to generate 3-dimensional representations of a subject, wherein the trained machine learning model comprises the trained first specialized network and the trained second specialized network.

In another embodiment, a system includes a computing device configured to receive image training data comprising images and associated image descriptions. The computing device is also configured to apply a first specialized network to the machine training data to obtain a trained first specialized network. The computing device is further configured to apply a first specialized network to the image training data to obtain a trained first specialized network. The computing device is additionally configured to receive 3-dimensional representation training data comprising images and associated 3-dimensional representations. The computing device is further configured to apply a second specialized network to the 3-dimensional training data to obtain a trained second specialized network. The computing device is also configured to determine a trained machine learning model to generate 3-dimensional representations of a subject, wherein the trained machine learning model comprises the trained first specialized network and the trained second specialized network.

In another embodiment, a non-transitory computer readable medium is provided which includes program instructions executable by at least one processor to cause the at least one processor to perform functions of receiving image training data comprising images and associated image descriptions. The functions include applying a first specialized network to the image training data to obtain a trained first specialized network. The functions also include receiving 3-dimensional representation training data comprising images and associated 3-dimensional representations. The functions additionally include applying a second specialized network to the 3-dimensional training data to obtain a trained second specialized network. The functions further include determining a trained machine learning model to generate 3-dimensional representations of a subject, wherein the trained machine learning model comprises the trained first specialized network and the trained second specialized network.

In a further embodiment, a system is provided that includes means for receiving image training data comprising images and associated image descriptions. The system also provides means for applying a first specialized network to the image training data to obtain a trained first specialized network. The system additionally includes means for receiving 3-dimensional representation training data comprising images and associated 3-dimensional representations. The method further includes means for applying a second specialized network to the 3-dimensional training data to obtain a trained second specialized network. The method also includes means for determining a trained machine learning model to generate 3-dimensional representations of a subject, wherein the trained machine learning model comprises the trained first specialized network and the trained second specialized network.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a diagram illustrating training and inference phases of a machine learning model, in accordance with example embodiments.

FIG. 2 is a flowchart of a method, in accordance with example embodiments.

FIG. 3 is a flowchart of a method, in accordance with example embodiments.

FIG. 4 illustrates automatically generated 3D human avatars, in accordance with example embodiments.

FIG. 5 is a table summarizing characteristics of a method in comparison to other works, in accordance with example embodiments.

FIG. 6 illustrates components for generating 3D human avatars, in accordance with example embodiments.

FIG. 7 illustrates back view generation, in accordance with example embodiments.

FIG. 8 illustrates a reposing example, in accordance with example embodiments.

FIG. 9 illustrates diversity of 3D generation, in accordance with example embodiments.

FIG. 10 is a table showing comparisons with other text-to-3D human generation methods, in accordance with example embodiments.

FIG. 11 illustrates comparisons with text-to-3D human generation methods, in accordance with example embodiments.

FIG. 12 is a table with numerical comparisons of single-view 3D reconstructions methods, in accordance with example embodiments.

FIG. 13 illustrates qualitative comparisons with state-of-the-art single image 3D reconstruction methods, in accordance with example embodiments.

FIG. 14 illustrates additional comparisons with TeCH, in accordance with example embodiments.

FIG. 15 illustrates identity preserving 3D avatar editing, in accordance with example embodiments.

FIG. 16 illustrates a partial vs. complete fine-tuning strategy, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. OVERVIEW

Three-dimensional (3D) representations of various subjects may be generated from text using machine learning models. However, these machine learning models may be difficult to train accurately due to limited training data associating text with 3D representations. Accordingly, generating 3D representations of various subjects may follow an optimization approach where the models are optimized with generating each 3D representation. However, models following such approaches may take a significant amount of time to generate a 3D representation as optimizing the model together with generating an output may take more time than simply generating an output.

The present disclosure includes using a plurality of specialized networks in a machine learning model to generate a 3D representation of a subject. Each of the specialized networks may be trained separately. In an example implementation, the machine learning model may include a first specialized network that generates images based on descriptions of a subject and a second specialized network that generates 3D representations based on images. The first specialized network may be trained based on a training set of text or images and associated images and the second specialized network may be trained based on a training set of images and associated 3D representations. Such training data may be more readily available than text to 3D representations and may allow for the machine learning model to be a pretrained feed-forward network that may generate 3D representations faster than an optimization based model. The machine learning model may also include a third specialized network, which may generate one or more additional images based on the images generated from the first specialized network. These additional images may be different views of a subject pictured in the images generated from the first specialized network. The second specialized network may take as inputs the first the images generated by the first specialized network and the additional images generated by the second specialized network to generate a 3D representation.

### II. EXAMPLE SYSTEMS AND METHODS

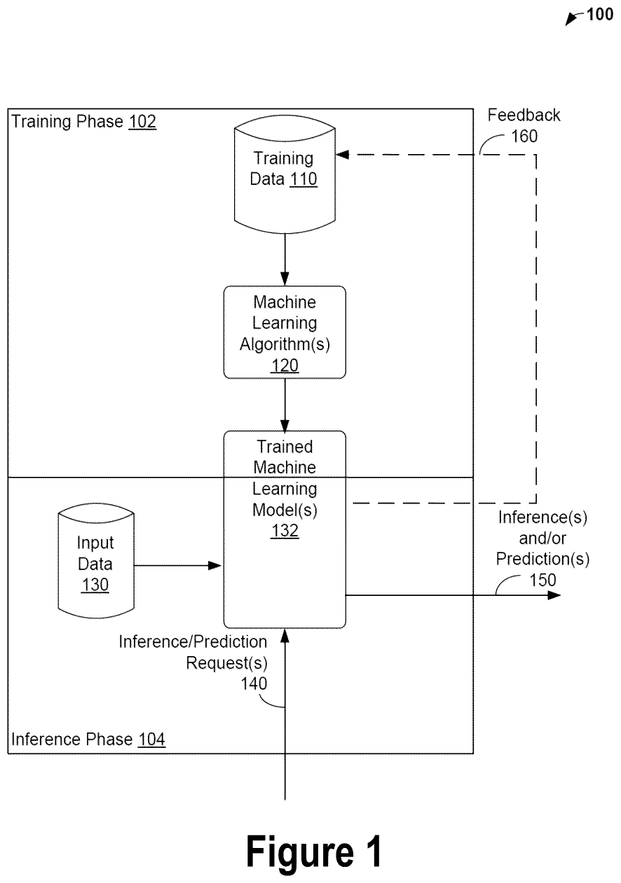

FIG. 1 shows diagram 100 illustrating a training phase 102 and an inference phase 204 of trained machine learning model(s) 132, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 1 shows training phase 102 where one or more machine learning algorithms 120 are being trained on training data 110 to become trained machine learning model 132. Producing trained machine learning model(s) 132 during training phase 102 may involve determining one or more hyperparameters, such as one or more stride values for one or more layers of a machine learning model as described herein. Then, during inference phase 104, trained machine learning model 132 can receive input data 130 and one or more inference/prediction requests 140 (perhaps as part of input data 130) and responsively provide as an output one or more inferences and/or predictions 150. The one or more inferences and/or predictions 150 may be based in part on one or more learned hyperparameters, such as one or more learned stride values for one or more layers of a machine learning model as described herein

As such, trained machine learning model(s) 132 can include one or more models of one or more machine learning algorithms 120. Machine learning algorithm(s) 120 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 120 may be supervised or unsupervised, and may implement any suitable combination of online and offline learning.

In some examples, machine learning algorithm(s) 120 and/or trained machine learning model(s) 132 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 120 and/or trained machine learning model(s) 132. In some examples, trained machine learning model(s) 132 can be trained, reside and execute to provide inferences on a particular computing device, and/or otherwise can make inferences for the particular computing device.

During training phase 102, machine learning algorithm(s) 120 can be trained by providing at least training data 110 as training input using unsupervised, supervised, semi-supervised, and/or reinforcement learning techniques. Unsupervised learning involves providing a portion (or all) of training data 110 to machine learning algorithm(s) 120 and machine learning algorithm(s) 120 determining one or more output inferences based on the provided portion (or all) of training data 110. Supervised learning involves providing a portion of training data 110 to machine learning algorithm(s) 120, with machine learning algorithm(s) 120 determining one or more output inferences based on the provided portion of training data 110, and the output inference(s) are either accepted or corrected based on correct results associated with training data 110. In some examples, supervised learning of machine learning algorithm(s) 120 can be governed by a set of rules and/or a set of labels for the training input, and the set of rules and/or set of labels may be used to correct inferences of machine learning algorithm(s) 120.

Semi-supervised learning involves having correct results for part, but not all, of training data 110. During semi-supervised learning, supervised learning is used for a portion of training data 110 having correct results, and unsupervised learning is used for a portion of training data 110 not having correct results.

Reinforcement learning involves machine learning algorithm(s) 120 receiving a reward signal regarding a prior inference, where the reward signal can be a numerical value. During reinforcement learning, machine learning algorithm(s) 120 can output an inference and receive a reward signal in response, where machine learning algorithm(s) 120 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 120 and/or trained machine learning model(s) 132 can be trained using other machine learning techniques, including but not limited to, incremental learning and curriculum learning.

In some examples, machine learning algorithm(s) 120 and/or trained machine learning model(s) 132 can use transfer learning techniques. For example, transfer learning techniques can involve trained machine learning model(s) 132 being pre-trained on one set of data and additionally trained using training data 110. More particularly, machine learning algorithm(s) 120 can be pre-trained on data from one or more computing devices and a resulting trained machine learning model provided to computing device CD1, where CD1 is intended to execute the trained machine learning model during inference phase 104. Then, during training phase 102, the pre-trained machine learning model can be additionally trained using training data 110. This further training of the machine learning algorithm(s) 120 and/or the pre-trained machine learning model using training data 110 of CD1's data can be performed using either supervised or unsupervised learning. Once machine learning algorithm(s) 120 and/or the pre-trained machine learning model has been trained on at least training data 110, training phase 102 can be completed. The trained resulting machine learning model can be utilized as at least one of trained machine learning model(s) 132.

In particular, once training phase 202 has been completed, trained machine learning model(s) 132 can be provided to a computing device, if not already on the computing device. Inference phase 104 can begin after trained machine learning model(s) 132 are provided to computing device CD1.

During inference phase 104, trained machine learning model(s) 132 can receive input data 130 and generate and output one or more corresponding inferences and/or predictions 150 about input data 130. As such, input data 130 can be used as an input to trained machine learning model(s) 132 for providing corresponding inference(s) and/or prediction(s) 150. For example, trained machine learning model(s) 132 can generate inference(s) and/or prediction(s) 1150 in response to one or more inference/prediction requests 240. In some examples, trained machine learning model(s) 132 can be executed by a portion of other software. For example, trained machine learning model(s) 132 can be executed by an inference or prediction daemon to be readily available to provide inferences and/or predictions upon request. Input data 130 can include data from computing device CD1 executing trained machine learning model(s) 132 and/or input data from one or more computing devices other than CD1.

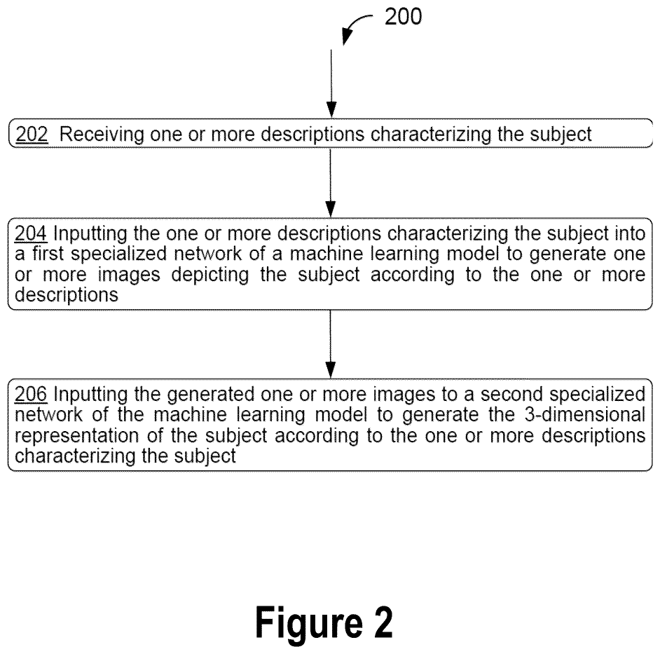

FIG. 2 is a flow chart of method 200 of generating a 3D representation of a subject. Method 200 may be executed by one or more processors.

At block 202, method 200 may include receiving one or more descriptions characterizing the subject.

At block 204, method 200 may include inputting the one or more descriptions characterizing the subject into a first specialized network of a machine learning model to generate one or more images depicting the subject according to the one or more descriptions.

At block 206, method 200 may include inputting the generated one or more images to a second specialized network of the machine learning model to generate the 3D representation of the subject according to the one or more descriptions of the subject.

In some embodiments, method 200 further comprises inputting the one or more generated images into a third specialized network of the machine learning model to generate one or more further images, wherein the one or more further images are input into the second specialized network together with the generated one or more images.

In some embodiments, the generated one or more images includes a front view image of the subject and the generated one or more further images includes a back view of the subject.

In some embodiments, the one or more descriptions characterizing the subject are not input into the third specialized network of the machine learning model together with the one or more images.

In some embodiments, the subject is a person or a statue.

In some embodiments, the machine learning model is a pretrained feed-forward network.

In some embodiments, the one or more descriptions comprises an image of a pose of the subject.

In some embodiments, the one or more descriptions comprise a hair color of the subject or a clothing item of the subject.

In some embodiments, method 200 further comprises, based on the generated 3D representation of the subject, determining one or more further 3D representations of the subject in one or more further poses.

In some embodiments, the first specialized network comprises one or more convolutional layers, one or more attention layers, and one or more decoder layers.

In some embodiments, the first specialized network is fine-tuned on a dataset of a plurality of images and associated descriptions whereby one or more attention weights associated with the one or more attention layers and one or more decoder weights associated with the one or more decoder layers are held constant during fine-tuning of the first specialized network.

In some embodiments, the one or more images are 2-dimensional images.

In some embodiments, the one or more descriptions are not input into the second specialized network.

In some embodiments, method 200 further comprises taking one or more actions based on the generated 3D representation of the subject.

In some embodiments, taking one or more actions comprises animating the 3D representation of the subject.

In some embodiments, taking one or more actions comprises simulating one or more objects on the 3D subject.

In some embodiments, method 200 further comprises receiving an image of the subject, wherein the received image of the subject is input into the first specialized network of the machine learning model together with the one or more descriptions characterizing the subject to generate one or more images depicting the subject.

In some embodiments, the received image is a different view of the subject than the generated one or more images.

In some embodiments, method 200 further comprises receiving further user input indicating further descriptions characterizing the subject and updating the 3D representation of the subject according to the further user input.

In some embodiments, the 3D representation is an avatar representation in an interactive graphical user interface.

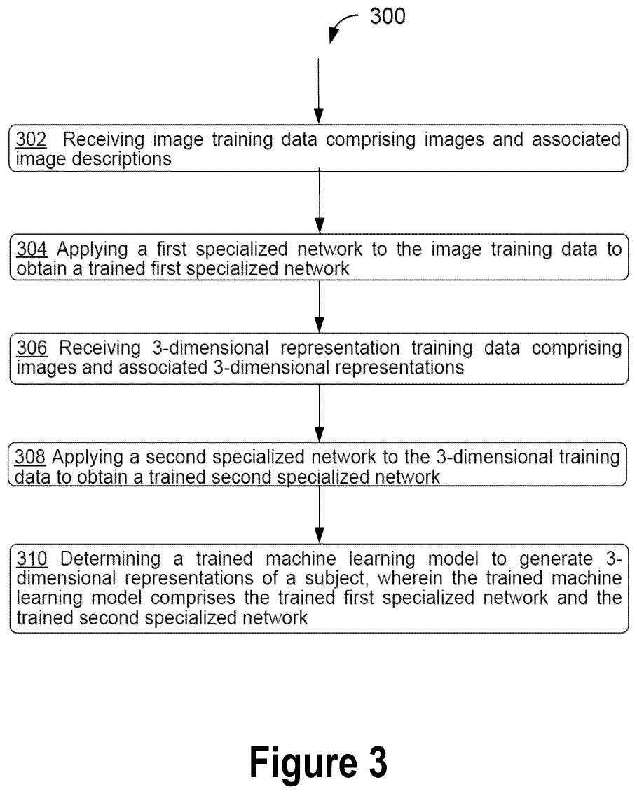

FIG. 3 is a flow chart of a method 300, in accordance with example embodiments. Method 300 may be executed by one or more processors.

At block 302, method 300 may include receiving image training data comprising images and associated image descriptions.

At block 304, method 300 may include applying a first specialized network to the image training data to obtain a trained first specialized network.

At block 306, method 300 may include receiving 3D representation training data comprising images and associated 3D representations.

At block 308, method 300 may include applying a second specialized network to the 3D training data to obtain a trained second specialized network.

At block 310, method 300 may include determining a trained machine learning model to generate 3D representations of a subject, wherein the trained machine learning model comprises the trained first specialized network and the trained second specialized network.

In some embodiments, a system may include a processor and a non-transitory computer-readable medium having stored thereon instructions that, when executed by the processor, cause the processor to perform operations in accordance with any of methods described above and/or below.

In some embodiments, a non-transitory computer-readable medium having stored thereon instructions that, when executed by a computing device, may cause the computing device to perform operations in accordance with any of the methods described above and/or below.

### III. EXAMPLE APPLICATIONS

In some embodiments, the methods as described herein may be used for generating 3D representations of people (e.g., avatars). The machine learning model as described herein may be used to generate one or more different views of a person in addition to simulating clothes or accessories worn by the person.

In some embodiments, the methods described herein may be used to generate 3D representations of animals, trees, flowers, and wildlife in general.

In some embodiments, the methods described herein may be used to generate virtual worlds, for example in the context of various computer games or simulations. The methods described herein may be used to generate people, animals, plants, buildings, among other examples for a computer game or simulation.

In some embodiments, the methods described herein may be used to facilitate generating 3D videos or movies, including, for example, animations. Words spoken or described in a script may trigger generating a subject in a particular pose or generating an existing subject in a different pose.

In some embodiments, the methods described herein may be used to facilitate development of virtual reality scenes. A computing system may generate one or more 3D subjects or objects in a virtual reality scene, such that the 3D subjects or objects may be viewed at different angles.

In some embodiments, the methods described herein may be used to facilitate photo editing software, perhaps to facilitate changing an angle at which a subject is photographed in a photo.

In some embodiments, the methods described herein may be used to facilitate video editing software or animation software.

### IV. EXAMPLE TECHNICAL BENEFITS

In some embodiments, the machine learning models described herein may be easier and faster to train. The machine learning model may include specialized networks, which may be trained separately. Each network of the machine learning model may be smaller and include less tunable parameters than the machine learning model as a whole. Further, one or more networks of the machine learning model may be fine-tuned based on previously determined parameters rather, which may be faster and easier than training a network in its entirety.

In some examples, the machine learning models described herein may use less memory to train due to each network of the machine learning model being smaller than the network as a whole.

In some embodiments, the machine learning models described herein may be quicker than other machine learning networks used to generate 3D representations. In particular, the methods described herein may use pretrained feed-forward networks rather than an optimization-based approach.

In some embodiments, the machine learning models described herein may use less power than other machine learning networks used to generate 3D representations. Compared to an optimization based approach, the machine learning models described herein may generate 3D representations without optimizing the machine learning model in parallel.

In some embodiments, the methods described herein may be implemented locally rather than on a separate computing system, which may help improve speed at which a subject or object is generated and shown to a user.

In some embodiments, the methods described herein may be more reliable. In particular, as the machine learning model is pretrained rather than being trained in parallel, training is not an issue while the machine learning model is being implemented. The training process may cause issues in the reliability of outputs (e.g., through undertraining or overtraining). However, rather than optimizing the machine learning models during the implementation process, machine learning models described herein may be pretrained.

In some examples, the methods provided herein may facilitate fine-tuning the machine learning model using smaller scale training datasets without inducing the machine learning model to produce inaccurate predictions that were previously correctly generated or otherwise forget accurate predictions.

In some embodiments, the methods provided herein may be used on a wider variety of devices. In particular, the methods provided herein may facilitate a faster machine learning model that uses less memory, which may allow the methods described herein to be used on mobile devices, laptops, and other devices with limited memory.

### V. EXAMPLE METHODS

Examples method are described for the instant creation of rigged full-body 3D human avatars, with multimodal control in the form of text, images, and/or a given human pose and shape. The remarkable recent progress in image synthesis acted as a catalyst for a wide range of media generation applications. In just a few years, there have been rapid developments in video generation, audio synthesis, or text-to-3D object generation, among others. Pivotal to success of all these methods is their probabilistic nature but this requires very large training sets. While inspiring efforts have been made, large training sets are still a problem in many domains, and particularly for 3D. In an attempt to alleviate the need for massive 3D datasets, DreamFusion (see: Poole, B. et al.: Dreamfusion: Text-to-3D using 2D diffusion. In: Int. Conf. Learn. Represent. (2022) 2, 3, 9) leverages the rich priors of text-to-image diffusion models in an optimization framework. The influential DreamFusion ideas were also quickly adopted for 3D avatar creation, a field previously dominated by image or video-based reconstruction solutions. Text-to-avatar methods enabled novel creative processes, but came with a significant drawback. While image-based methods typically use pretrained feed-forward networks and create outputs in seconds, existing text-to-avatar solutions are optimization-based and take minutes to several hours to complete, per instance.

It is an aim of the present disclosure to close this gap and present, for the first time, methodology for instant text-controlled rigged full-body 3D human avatar creation. Methods of the present embodiments are purely feed-forward, may be conditioned on images and textual descriptions, may allow for fine-grained control over the generated body pose and shape, can generate multiple hypotheses, and may run in 2-10 seconds per instance.

Key to success is the pragmatic decoupling of the two stages of (1) probabilistic text-to-image generation and (2) 3D lifting. Decoupling 2D generation and 3D lifting has two major advantages: (1) The power of pretrained text-to-image generative networks can be leveraged, which have shown impressive results in modeling complex conditional distributions. Trained with large training sets of images, their generation diversity is very high. (2) The need for very large 3D datasets required by state-of-the-art generative 3D models may be alleviated. This method generates diverse plausible image configurations that contain rich enough information that can be lifted in 3D with minimal ambiguity. In other words, the workload between two expert systems is distributed: a pretrained text-to-image probabilistic generation network fine-tuned for the task to produce consistent front and back image views of the person, and a state-of-the-art unimodal, feed-forward image-to-3D model that can be trained using comparably small datasets.

The proposed decoupling strategy may allow one to maximally exploit available data sources with different degrees of supervision. A pretrained Latent Diffusion network may be fine-tuned to generate images of people based on textual descriptions and with additional control over the desired pose and shape. This step does not require any ground truth 3D data for supervision and enables scaling the image generator to web scale data of images of people in various poses. Additionally, a small-scale dataset of scanned 3D human assets may be leveraged and a second latent diffusion network may be fine-tuned to learn the distribution of back side views based on a front view image of the person, and optionally, a textual description that could naturally complement the evidence available in the front view image.

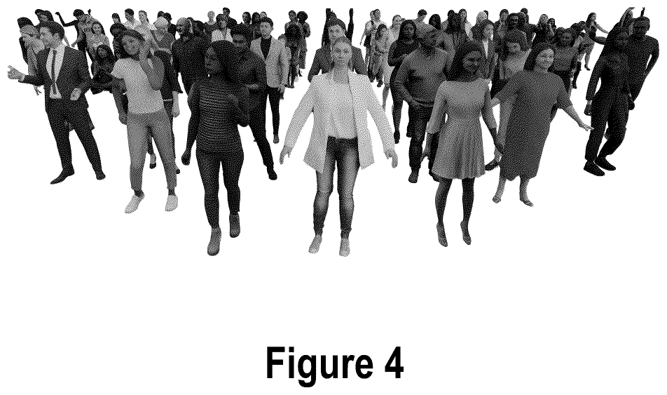

Furthermore, a novel fine-tuning strategy is proposed that prevents overfitting to the new datasets. A 3D reconstruction network may be designed and trained that predicts a textured 3D shape in the form of an implicit signed distance field given the pair of front and back views and optionally 3D body signals. The resulting cascaded methods may support a wide range of 3D generation and reconstruction tasks: the example embodiments enable fast and interactive 3D generation of assets at scale, see FIG. 4. In this example, 77 models generated from various text prompts in 12 minutes on a single GPU are shown. Furthermore, parts of the cascade can be repurposed for image-based 3D reconstruction at state-of-the-art quality. Additionally, it is demonstrated how these example methods can be used for creative editing tasks exemplified in 3D virtual try-on with body shape preservation.

A multiple hypotheses method is described for controllable 3D human avatar generation, based on multimodal text, pose, shape and image input signals, that outputs a detailed human mesh instance in 2-10 seconds.

A simple yet effective way is provided to fine-tune pretrained diffusion models on small-scale datasets, without inducing catastrophic forgetting is proposed.

This approach may achieve state-of-the art results in single-image 3D reconstruction and may enable 3D creative editing applications.

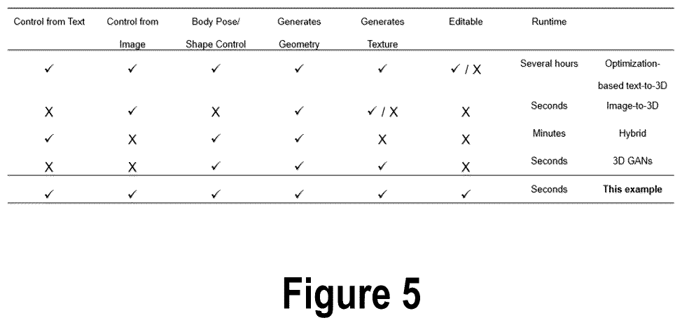

The table in FIG. 5 summarizes the characteristics of methods of an example embodiment in comparison to previous work, along several important property axes. It is shown that this method generates 3D assets with texture from text prompts or input images of a target subject and can be controlled with body pose and shape. In contrast to baselines that require up to hours per prompt, this model takes under five seconds and can de facto by used in interactive applications. In the experimental section, the large diversity of the model, and applications in cloth editing are demonstrated.

The success of text-to-image models was quickly followed by a significant amount of work on text-to-3D content generation. Due to limited training data, methods typically follow an optimization approach. Hereby a neural representation is optimized per instance and by minimizing a distillation loss derived from large text-to-image models. This idea has been extended to generate human avatars or heads enabling the text-based creation of 3D human assets that are diverse in terms of shape, appearance, clothing and various accessories. In these works, the optimization process is often regularized using a 3D body model, which also enables animation. However, such approaches generally take hours per instance, and rendering is slow. With the appearance of Gaussian Splatting, other works reduced rendering time at the expense of accurate geometry. In any case, creating an avatar still takes a significant amount of time, making such methods unsuitable for interactive applications. In this work an alternative direction is proposed, which also builds upon the success of (2D) text-to-image models, but combines them with 3D reconstruction pipelines. Related are also 3D generative human methods. AG3D (see: Dong, Z., et al.: AG3D: Learning to generate 3D avatars from 2D image collections. In: International Conference on Computer Vision (ICCV) (2023) 3, 4) and EVA3D (see: Hong, F., et al.: EVA3d: Compositional 3D human generation from 2D image collections. In: International Conference on Learning Representations (2023), https://openreview.net/forum?id=g7U9jD2CUr 3, 4) are GAN-based methods learned from 2D data that allow to sample 3D humans anchored in a 3D body model. CHUPA (see: Kim, B., et al.: Carving 3D clothed humans from skinned shape priors using 2D diffusion probabilistic models. arXiv preprint arXiv:2305.11870 (2023) 3, 4, 9) generates dual normal maps based on text and then fits a body model to obtain a full 3D representation. While generation is similar in spirit to the method disclosed here, CHUPA requires optimization per instance and does not generate texture.

This framework generates 3D human assets and is closely related to 3D reconstruction. This has been widely explored in the past and can be roughly categorized by its use of explicit or implicit representations. An important line of work leverages 3D body models and reconstructs their associated parameters, in some cases extended with vertex offsets to represent some clothing and hair detail. Other efforts have considered voxels, depth maps and more recently implicit representations. Being topology free, the latter allow the representation of loose clothing more easily. They typically provide more detail and enable high-resolution reconstruction, often conditioned on local pixel-aligned features. On the other hand, these methods yield reconstructions with no semantic labels that cannot be easily animated. To solve this problem, some work combined body models with implicit representations, but this is prone to errors when the pose is noisy at inference time. In contrast, the synthesis process here is driven with guidance from an input body model—sampled or estimated—so that the generated image is well aligned with the body prior. This allows rigging the 3D avatar without post-processing and natively supports 3D animation.

Given a single input image of a person, previous work aims to generate non-visible parts realistically. However, this often leads to blurry and little detail in the non-visible parts (e.g. wrinkles). Some methods generate back normal maps to gain detail, or consider probabilistic reconstructions. However, all these methods cannot be prompted from text or other modalities and still yield limited diversity. In contrast, the synthesis process is guided by means of generated front and back images, as well as optionally body pose and shape, yielding high-quality 3D reconstructions. Another challenge in previous work is limited training data. Most prior methods rely on a few hundred 3D scans, due to the pricey and laborious process of good quality human capture. This present disclosure alleviates the need for large scale 3D training data by proposing a framework that can quickly generate humans with a given clothing, pose and shape.

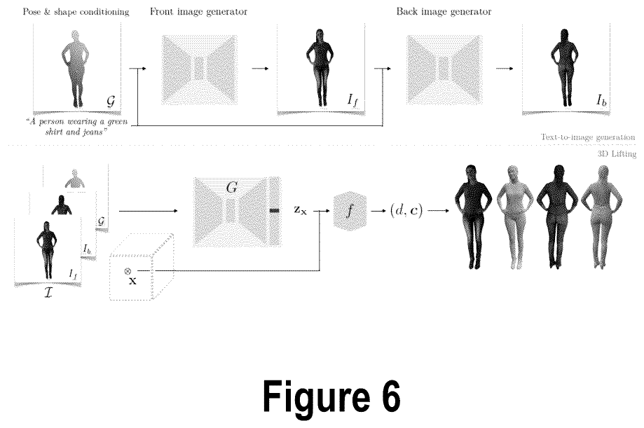

A summary of an example method is shown in FIG. 6. A distribution p(X|c) of textured 3D shapes X is conditioned on a collection of signals c. In this example, 77 models generated from various text prompts in 12 minutes on a single GPU are shown may be factorized as follows

$$p ( X \vert c ) = \int \int p ( X \vert {I}_{f} , {I}_{b} , c ) \cdot p ( {I}_{b} \vert {I}_{f} , c ) \cdot p ( {I}_{f} \vert c ) {dI}_{f} {dI}_{b}$$

where p(X|I_{f}, I_{b}, c) is the probability of 3D shape X given c and front and back image observations (views) I_{f} and I_{b} respectively, p(I_{b}|I_{f}, c) is the probability of the back view image given the front image I_{f} and conditioning signals c, and p(I_{f}|c) the conditional probability of front view images of the person given c.

Computing the integral is intractable, but the goal is to generate samples from the distribution rather than expectations. To do so, ancestral sampling may be employed. A front view of I_{f} given c is sampled, a back view of I_{b} given I_{f} and c is sampled, and the 3D reconstruction is sampled based on the entire context. In practice, p(I_{f}|c) and p(I_{b}|I_{f}, c) may be implemented using Latent Diffusion models, whereas p(X|I_{f}, I_{b}, c) is a Gaussian (unimodal), neural implicit field generator.

In the case of single-image 3D reconstruction the conditioning signal c is I_{f}, and consequently the corresponding step can be omitted. For text-based generation, c is a text prompt describing the appearance of the person together with a signal encoding the body pose and shape. c may be extended with additional signals, as in the case of 3D editing.

Recent advances in diffusion-based text-to-image generation networks have enabled synthesizing high-quality images given only a text prompt as input. However, for certain use cases, such as human generation, it is difficult to inject fine-grained, inherently continuous forms of control, like the 3D pose of people or their precise body shape proportions, in generation with text alone.

Inspired by ControlNet (see: Zhang, L., et al.: Adding conditional control to text-to-image diffusion models. IEEE International Conference on Computer Vision (ICCV) (2023) 6), it is proposed to add simultaneous control over body pose and shape by augmenting a pretrained Latent Diffusion network with an additional image input that jointly encodes both modalities. For control GHUM (see: Xu, H., et al.: Ghum & ghuml: Generative 3D human shape and articulated pose models. In: CVPR (2020) 4, 6) may be used but other models can also be used. Specifically given 3D pose and shape parameters θ and β respectively, the corresponding mesh M=GHUM(θ, β) may be rendered using GHUM's template coordinates and posed vertex locations as 6D vertex colors, obtaining a dense, pixel-aligned pose- and shape-informed control signal G.

To fine-tune the network, a dataset of images of people may be generated with corresponding GHUM 3D pose and shape parameters and text-annotations. This dataset may be comprised of a set of scanned assets that are rendered from different viewpoints, as well as a set of real images scraped from the web. For the synthetic part of the dataset, the pose and shape parameters may be obtained by fitting GHUM to 3D scans. Additionally, real images may be used to fit GHUM using keypoint optimization in the style of Kolotouros et al. (see: Kolotouros, N., et al.: Dreamhuman: Animatable 3D avatars from text. Advances in Neural Information Processing Systems 36 (2024) 2, 3, 4, 9). For all images the text annotations may be obtained using an off-the shelf image captioning system by prompting it to describe the clothing of the people in the image. In the interest of generating 3D human assets, the background in all images may be masked, and the network may be trained to output segmented images. This makes the downstream 3D reconstruction task easier, and improves the reconstruction quality because it focuses the network on human appearance, rather than allocating capacity to model complex backgrounds.

The present embodiments may exploit the rich priors learned by text-to-image foundation models by fine-tuning a Latent Diffusion model with the dense GHUM rendering as an additional input. For fine-tuning a simpler and more lightweight method than a standard ControlNet is proposed. The weights of the input convolutional layer may be padded with additional channels initialized with zeros, and then only the weights of the convolutional layers of the encoder network may be fine-tuned. All the decoder and attention layers are kept frozen. With this simple strategy, even though the model is trained on a relatively small set of images, it may be able to generalize to unseen types of clothing. At the same time, this strategy may be more practical than training a ControlNet—as that involves keeping in separate copy of the original network weights in memory—and thus may enable fine-tuning large models with moderate hardware utilization. The encoder of the diffusion model may be optimized by minimizing the simple variant of the diffusion loss

$$L ( {ψ}_{enc} ) = {𝔼}_{ϵ ( x ) , ϵ , t , τ , G} ‖ ϵ - ϵψ ( {z}_{t} , t , τ , ε ( G ) ) ‖ ,$$

where t∈{1, . . . , T} is the diffusion time step, ϵ˜N(0, I) the injected noise zₜ=αₜ∈(x)+vₜ is the noisy image latent, τ is the text encoding, ε (G) the latent encoding of the dense GHUM signal, and ψ_{enc} the encoder subset of the denoising UNet parameters ψ.

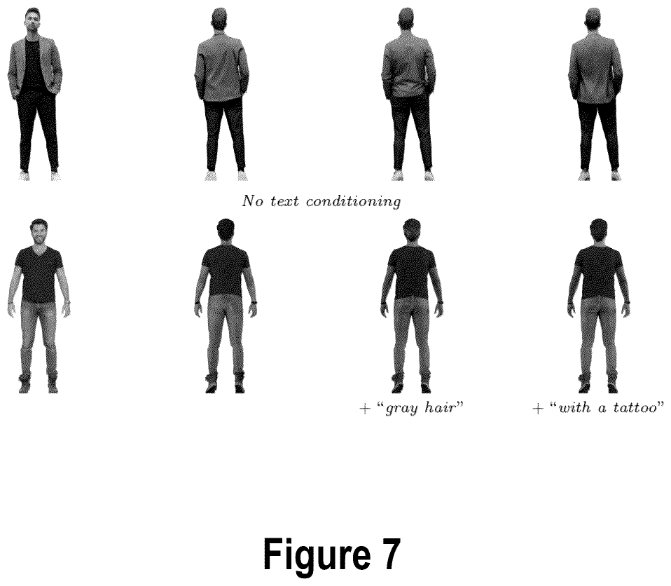

One could try to lift the generated front image/views from the previous stage to 3D directly by applying a single-image 3D reconstruction method like PHORHUM (see: Bar-Tal, O., et al.: Lumiere: A space-time diffusion model for video generation. arXiv preprint arXiv:2401.12945 (2024) 2). However, because of the inherent ambiguity of the problem this will result in significant loss of geometric detail and blurry textures for the non-visible body surfaces. To avoid it, it is proposed to fine-tune again a latent diffusion network with the same strategy as in the previous section. This time the additional image conditioning is a front view and optionally a text prompt, and the network is trained to learn the distribution of back views conditioned on the front view. The additional text prompt can be used in cases where it is desired to additionally guide the generation by very specific properties. FIG. 7 shows different back sides sampled from the conditional distribution. It is also shown that the additional text inputs may be useful in modulating certain parts of the generation that are not immediately deducible from the front image, such as hairstyles or specific patterns.

This 3D reconstruction network is inspired by PHORHUM (see: Bar-Tal, O., et al.: Lumiere: A space-time diffusion model for video generation. arXiv preprint arXiv:2401.12945 (2024) 2), and the design choices are informed by the limitations of typical single-image 3D reconstruction methods. Specifically, given a collection of input image signals I={I_{f}, I_{b}, G}, they are first concatenated, and then a convolutional encoder G may be used to compute a pixel-aligned feature map G(I). Hereby, G is optional and may be omitted, e.g. for single-image reconstruction. Then, each point x∈ [symbol] ³ in the scene gets projected on this feature map to get pixel-aligned features zₓ=g(I, x; π)=b(G(I), π(x)) using interpolation, where b(·) is the bilinear sampling operator and π(x) is the pixel location of the projection of x using the camera π. These pixel aligned features are then concatenated with a positional encoding γ(x) of the 3D point and are fed to an MLP f that outputs the signed distance from the surface d as well as surface color c. Finally, the 3D shape S is represented as the zero-level-set of d

$$S ( I ) = \{ x ∈ {ℝ}^{3} \vert f ( g ( I , x ; π ) , γ ( x ) ) = ( 0 , c ) \} .$$

S can be transformed to a mesh, using Marching Cubes.

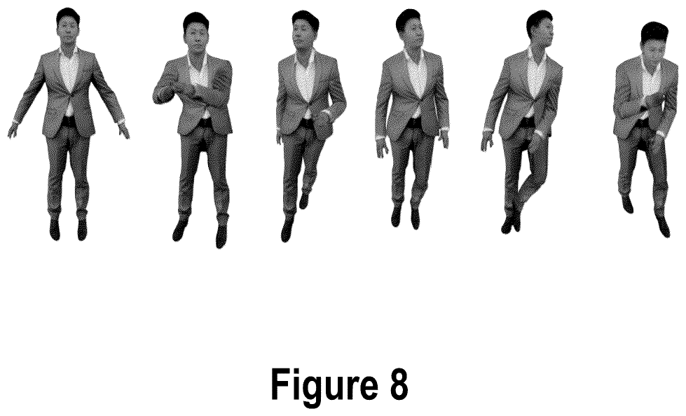

This method can generate diverse 3D avatars with various poses, shapes and appearances. Optionally, the conditioning body model may be leveraged to rig the estimated 3D shape. As a result of the conditioning strategy, 3D avatars and the conditional body model instances are aligned in 3D. This allows the reconstructed 3D shape to be anchored on the body model surface and be re-posed or re-shaped accordingly. Alternatively, just the LBS skeleton and weights may be transferred from the body model to the scan. This enables importing and animating the generated 3D assets in various rendering engines. See FIG. 8 for examples of the generated 3D assets.

Meshes from RenderPeople (see: https://renderpeople.com/) may be used for training as well as the captured data, totaling in ˜10K scans with diverse poses, body shapes, and clothing styles (e.g. training data 110). Each scan is rendered with randomly sampled HDRI background, random cloth color augmentations, and lighting using Blender (see: http://www.blender.org). During this process, both front and back views are rendered and used to train the different stages of the model. For the front image generation network a set of 10K real images on which we fitted the GHUM model using 2D keypoints is also used. For testing a split is defined based on subject identity and 1K scans were held out.

Results are provided for 2 different versions of the model (e.g. trained machine learning model 132). The standard quality model is generated in 2 seconds by running 5 DDIM (see: Song, J., et al.: Denoising diffusion implicit models. In: Int. Conf. Learn. Represent. (2020) 8) steps during inference and Marching Cubes at 2563 resolution. The high quality model is generated in 10 seconds using 50 DDIM steps and Marching Cubes at 5123 resolution. The timings were recorded on a single 40 GB A100 GPU. Unless otherwise stated, all reported results are obtained using the high quality model.

This method is compared numerically for two different problems. First the task of text-to-3D human generation is considered, where 100 different text prompts are sampled and compared against representative text-to-3D generation methods. For numerical comparisons the text-image alignment is evaluated using CLIP (see: Radford, A., et al.: Learning transferable visual models from natural language supervision. In: International conference on machine learning. pp. 8748-8763. PMLR (2021) 9). Specifically, the retrieval accuracy using CLIP is used. Furthermore, qualitative results are shown.

The performance of this 3D reconstruction component against state-of-the-art methods is validated considering both geometry and texture. Pixel-aligned image features dominate in recent work, but some methods aimed to combine them with body models, which offers advantages in being able to animate reconstructions. This relies on pixel-aligned features, yet a method is proposed that inherently enables animation. Methods of the example embodiments are run by generating the back side of the subject and applying the reconstruction method. To evaluate 3D geometry, the bi-directional Chamfer distance×10⁻³, Normal Consistency (NC ↑), and Volumetric Intersection over Union (IoU ↑) after ICP alignment are reported. However, these metrics do not necessarily correlate with good visual quality, e.g. Chamfer distance is minimized by smooth, non-detailed geometry. To measure the quality of reconstructions, additionally FID scores are reported of the front/back views for both geometry and texture.

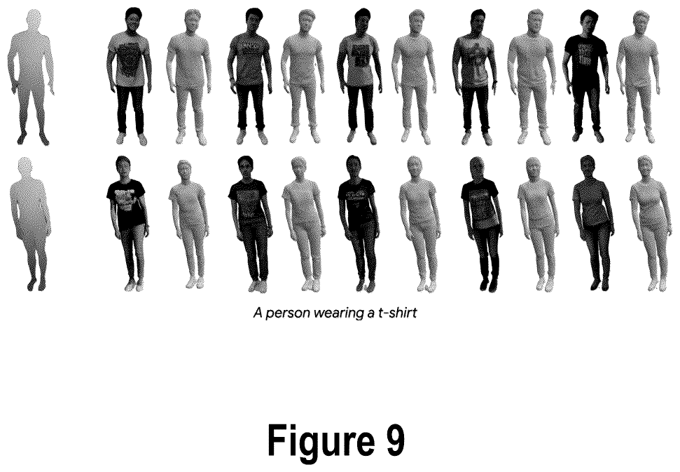

In FIG. 9 different avatars are generated given the same text prompt and driving poses. It can be seen that this model is able to create a very diverse set of assets, a property not observed in the previous text-to-3D generation methods.

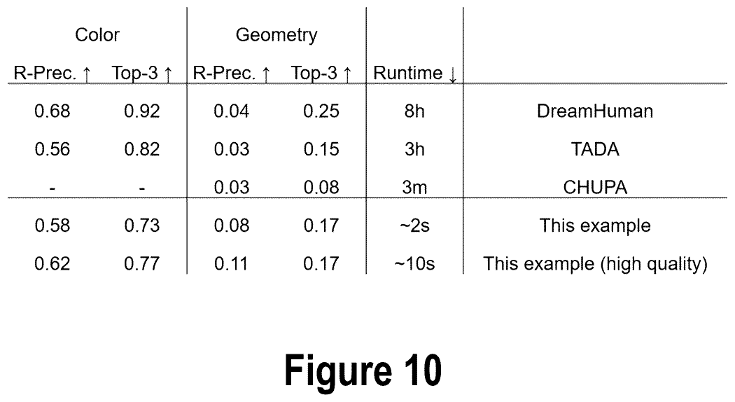

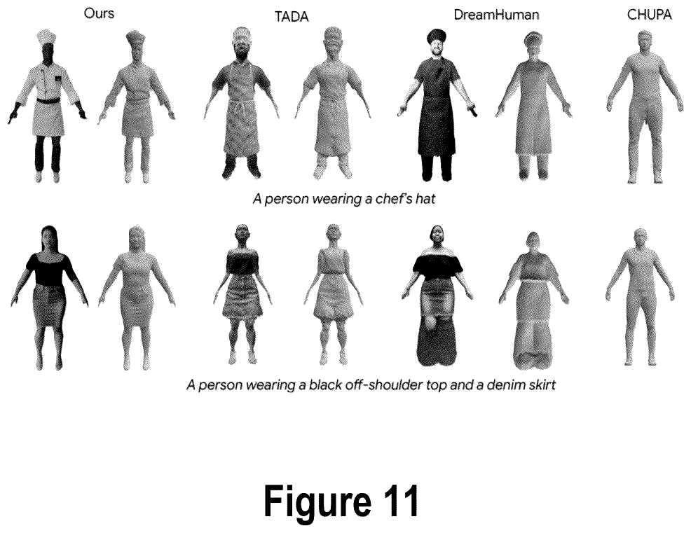

In the table in FIG. 10 CLIP is used to evaluate the model against other text-to-3D generation methods. In general, CLIP-based metrics are not indicative of the generated image quality, because they only consider the alignment with the text, and often over-saturated images with extreme details tend to have high CLIP scores. To further demonstrate that this method generates higher quality avatars, a qualitative comparison is included in FIG. 11.

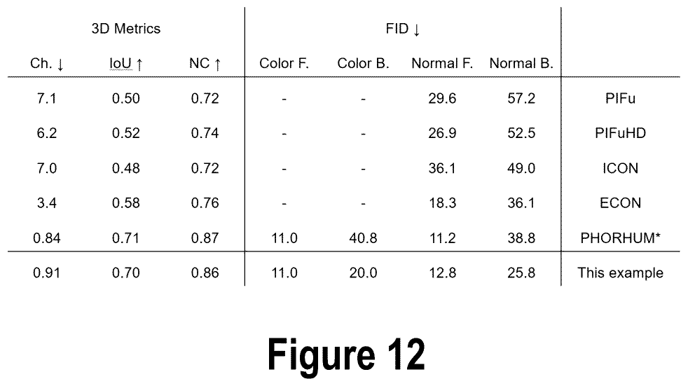

While not specifically designed for 3D reconstruction, this method shows state-of-the-art performance also for this task. The evaluation setup is the following: given an input image I, one random sample is drawn from the back view image generator network, and then this image is fed to the 3D reconstruction network. For all methods a textured 3D mesh was extracted using Marching Cubes and numerical results are reported in the table in FIG. 12. All Chamfer metrics are ×10⁻³. Not all methods generate colors. For fair comparisons, PHORHUM was retrained using the same data as the methods of the example embodiment. Comparable results in terms of 3D metrics are observed, however this example embodiment performs better on generating more realistic and diverse back views and back normals. While here a single image as input is used, it is also possible to optionally condition on text, body shape, and pose

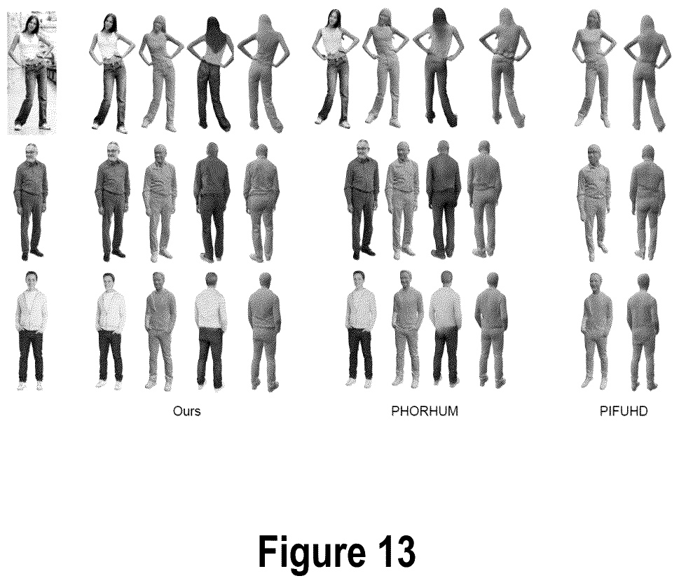

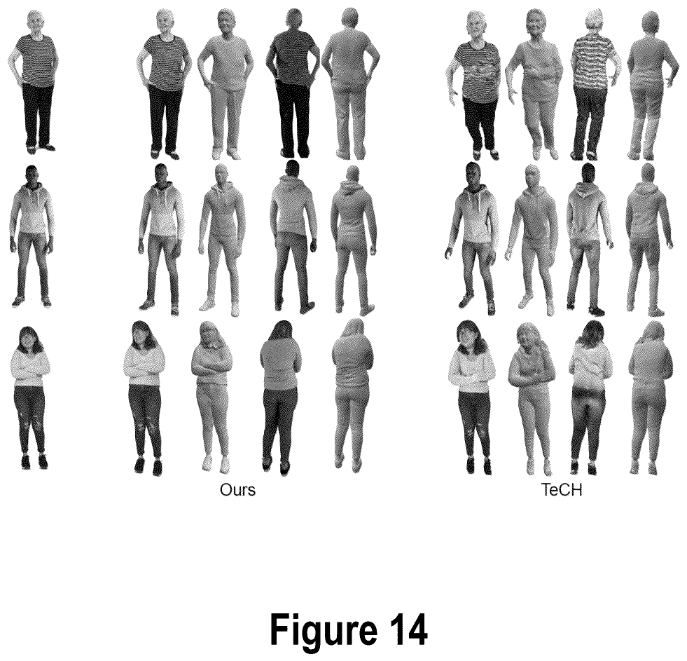

Furthermore, qualitative results are shown in FIG. 13. Notably, this method not only performs on par numerically and qualitatively on reconstructed front views, but also generates highly detailed back view texture and geometry. Finally, the optimization-based method TeCH (see: Huang, Y., et al.: TeCH: Text-guided Reconstruction of Lifelike Clothed Humans. In: International Conference on 3D Vision (3DV) (2024) 3, 4, 9, 10) is also compared with in FIG. 14. TeCH produces detailed front and back geometry but also exhibits problems at times, rooted in its 3D pose estimation method. Most importantly, TeCH runs for several hours per instance, while this example embodiment computes results in a single feed-forward pass, in only a few seconds.

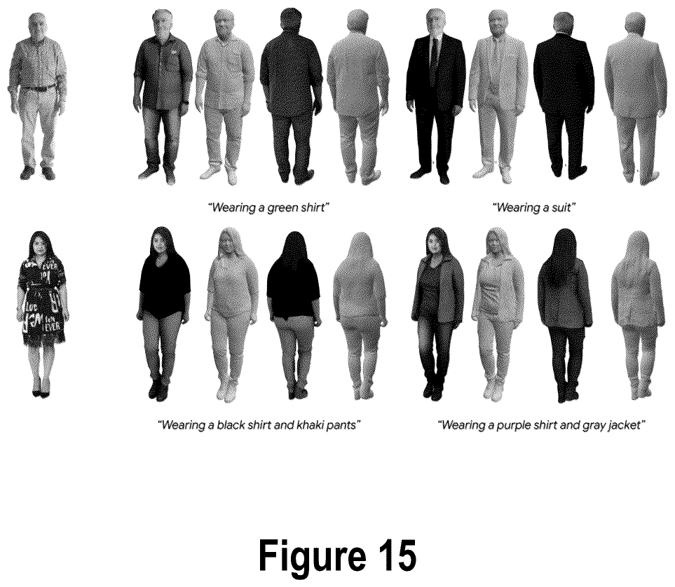

An immediate application of this method is the option to perform 3D garment edits for a given identity. Given an input image, 3D pose and shape parameters of the person in the image are recovered. Using an updated prompt and the identity preservation strategy introduced in the following, updated images can be generated of the same person wearing different garments or accessories. To preserve the identity of the person, first the person's head is located in the source image and then Repaint (see: Lugmayr, A., et al.: Re-paint: Inpainting using denoising diffusion probabilistic models. In: Proceedings of the IEEE/CVF Conference on Computer Vision and Pattern Recognition. pp. 11461-11471 (2022) 11) is used to out-paint a novel body for the given head. Hereby, the estimated shape parameters are continued to be conditioned to generate matching body proportions. In FIG. 15 such editing examples are illustrated. The generated 3D edits present garment details like wrinkles on both front and back views, and preserve the subjects' facial appearances. Also, note that body shape and identity are well preserved for the subjects, even though only one image is given. While there has been a significant amount of 2D virtual try-on research, this methodology can generate consistent and highly detailed 3D meshes that can be animated and rendered from other viewpoints.

The example embodiments enable animation of the generated assets by design, provided that its generation is conditioned on an underlying body model. In FIG. 8, an example is shown of a generated avatar that is rigged automatically.

In an ablation study, the effectiveness of the additional pose and shape encoding inputs G is compared to the reconstruction network during generation, where there is control over the target pose. To do so, the same set of 100 text prompts is used as before and for each text prompt sample a random pose and shape configuration. For each (τ, θ, β) triplet inferences are run and 2 meshes are computed: one using only the front and back images, and another one additionally using the dense GHUM encodings. The Chamfer distance between each mesh and the corresponding GHUM mesh is then evaluated. The model using the additional GHUM signals has an average Chamfer distance of d_{with}=1.4 whereas the one without d_{without}=8.6, thus validating the design choice. Not only is the control respected well, but this also allows for animation as discussed previously.

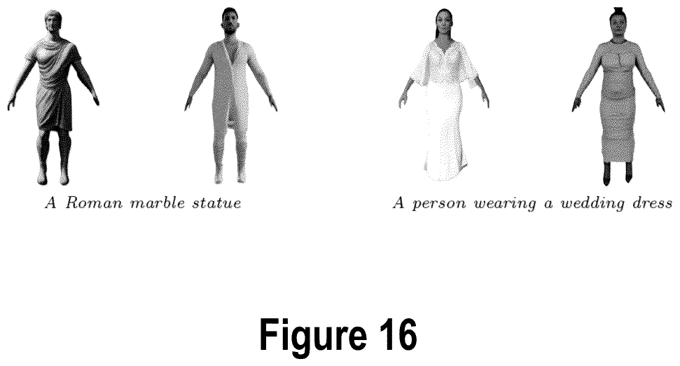

Two Latent Diffusion networks are fine-tuned, one in a standard way by optimizing all parameters, and another one using the proposed strategy where only the convolutional layers of the encoder are fine-tuned. Empirically it is observed that the network that was fine-tuned as a whole experienced catastrophic forgetting, and has poor performance when asked to generate types of garment not seen in the training set. FIG. 16 shows a comparison for text prompts not in the training set.

A generative tool to create 3D human assets is presented, thus reducing the risk of scanning and using real humans for training large scale 3D generative models. The example embodiments generate diverse results and can be controlled with body shape, clothing and other properties, which may lead to a better coverage of subject distributions and scale the amount of data available to the community.

A framework for generating 3D human avatars controlled by text or images and yielding rigged 3D models in 2-10 seconds, has been presented. The methods of the example embodiments are purely feed-forward, allows for fine-grained control over the generated body pose and shape, and can produce multiple qualitatively different hypotheses. The example methods are composed of a cascade of expert systems, decoupling image generation and 3D lifting. Through this design choice, these methods of the example embodiment benefit from both web-scale image datasets, ensuring high generation diversity, and from smaller size accurate 3D datasets, resulting in reconstructions with increased detail and precisely controlled based on text and identity specifications. In the future, one may explore other 3D construction strategies besides pixel-aligned features. Longer term, the aim is to support highly detailed and controllable 3D human model generation for entertainment, education, architecture and art, or medical applications.

### VI. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

What is claimed is:

1. A method of generating a 3-dimensional representation of a subject, the method comprising:
receiving one or more descriptions characterizing the subject;
inputting the one or more descriptions characterizing the subject into a first specialized network of a machine learning model to generate one or more images depicting the subject according to the one or more descriptions characterizing the subject; and
inputting the generated one or more images to a second specialized network of the machine learning model to generate the 3-dimensional representation of the subject according to the one or more descriptions characterizing the subject.

2. The method of claim 1, further comprising:
inputting the one or more generated images into a third specialized network of the machine learning model to generate one or more further images, wherein the one or more further images are input into the second specialized network together with the generated one or more images.

3. The method of claim 2, wherein the generated one or more images includes a front view image of the subject and the generated one or more further images includes a back view of the subject.

4. The method of claim 2, wherein the one or more descriptions characterizing the subject are not input into the third specialized network of the machine learning model together with the one or more images.

5. The method of claim 1, wherein the subject is a person or a statue.

6. The method of claim 1, wherein the machine learning model is a pretrained feed-forward network.

7. The method of claim 1, wherein the one or more descriptions comprises an image of a particular pose of the subject.

8. The method of claim 1, wherein the one or more descriptions comprises one or more textual descriptions of a hair color of the subject or of a clothing item of the subject.

9. The method of claim 1, further comprising:
based on the generated 3-dimensional representation of the subject, determining one or more further 3-dimensional representations of the subject in one or more further poses.

10. The method of claim 1, wherein the first specialized network comprises one or more convolutional layers, one or more attention layers, and one or more decoder layers and further wherein the first specialized network is fine-tuned on a dataset of a plurality of images and associated descriptions whereby one or more attention weights associated with the one or more attention layers and one or more decoder weights associated with the one or more decoder layers are held constant during fine-tuning of the first specialized network.

11. The method of claim 1, wherein the one or more images are 2-dimensional images.

12. The method of claim 1, wherein the one or more descriptions are not input into the second specialized network.

13. The method of claim 1, further comprising:
taking one or more actions based on the generated 3-dimensional representation of the subject, wherein taking one or more actions comprises at least one of:
animating the 3-dimensional representation of the subject; or
simulating one or more objects on the 3-dimensional subject.

14. The method of claim 1, further comprising receiving an image of the subject, wherein the received image of the subject is input into the first specialized network of the machine learning model together with the one or more descriptions characterizing the subject to generate one or more images depicting the subject.

15. The method of claim 14, wherein the received image is a different view of the subject than the generated one or more images.

16. The method of claim 1, further comprising:
receiving further user input indicating further descriptions characterizing the subject; and
updating the 3-dimensional representation of the subject according to the further user input.

17. The method of claim 1, wherein the 3-dimensional representation is an avatar representation in an interactive graphical user interface.

18. The method of claim 1, wherein the one or more descriptions comprise one or more captured images of the subject.

19. A method comprising:
receiving image training data comprising images and associated image descriptions;
applying a first specialized network to the image training data to obtain a trained first specialized network;
receiving 3-dimensional representation training data comprising images and associated 3-dimensional representations;
applying a second specialized network to the 3-dimensional training data to obtain a trained second specialized network; and
determining a trained machine learning model to generate 3-dimensional representations of a subject, wherein the trained machine learning model comprises the trained first specialized network and the trained second specialized network.

20. A system comprising:
a processor; and
a non-transitory computer-readable medium having stored thereon instructions that, when executed by the processor or a computing device, cause the processor or the computing device to perform operations comprising:
receiving one or more descriptions characterizing a subject;
inputting the one or more descriptions characterizing the subject into a first specialized network of a machine learning model to generate one or more images depicting the subject according to the one or more descriptions characterizing the subject; and
inputting the generated one or more images to a second specialized network of the machine learning model to generate a 3-dimensional representation of the subject according to the one or more descriptions characterizing the subject.
